(19) United States
(12) Patent Application Publication
(10) Pub. No.: US 2025/0348870 A1
(43) Pub. Date: Nov. 13, 2025

(54) SYSTEMS AND METHODS FOR ISSUING AN ARRANGEMENT FOR USE WITH AN ENTITY AT A UNIQUE GEOGRAPHIC LOCATION

(71) Applicant: The PNC Financial Services Group, Inc., Pittsburgh, PA (US)

(72) Inventors: Sunil Deshpande, Tampa, FL (US); David Richard Frascona, Fort Mill, SC (US); Matthew Thomas Huttenlock, Perkasie, PA (US); John Joseph Leach, San Diego, CA (US); Thomas Jerome Sovich, Cortland, OH (US); Rajesh Raman, Sewickley, PA (US); Judy Ann Marie Jablonski, Independence, OH (US); Lorraine Bonura, Edisto Island, SC (US); Maciek Janusz Dlugosz, Glenshaw, PA (US)

(73) Assignee: The PNC Financial Services Group, Inc., Pittsburgh, PA (US)

(21) Appl. No.: 19/277,849

(22) Filed: Jul. 23, 2025

Related U.S. Application Data
(62) Division of application No. 18/502,237, filed on Nov. 6, 2023.
(60) Provisional application No. 63/485,150, filed on Feb. 15, 2023.

(51) Int. Cl. G06Q 20/38; G06Q 20/10; G06Q 20/34; G06Q 20/40; G06Q 40/03

(52) U.S. Cl. CPC G06Q 20/385; G06Q 20/108; G06Q 20/351; G06Q 20/354; G06Q 20/4014; G06Q 20/4015; G06Q 40/03

(57) ABSTRACT

Systems, methods, and computer readable media for generating a one-time banking arrangement for use with an entity at a unique geographic location are disclosed. The systems and methods may involve receiving a unique token; receiving a first information associated with a requestor; performing, using the first information associated with the requestor, a first inquiry; generating a variety of arrangement options; receiving an input from the requestor; performing a second inquiry; and generating a one-time arrangement based on the input from the requestor and the second inquiry. Methods for obtaining and using a one-time arrangement with an entity at a unique geographic location are also disclosed. The methods may involve providing a unique token; providing an information associated with a requestor; receiving a variety of arrangement options; providing an input; receiving a one-time arrangement; and using the one-time arrangement to make a purchase with the entity at the unique geographic location.

### TECHNICAL FIELD

The present disclosure relates to systems, methods, and computer readable media for generating a variety of banking arrangement options with a geographically distinct entity. For example, disclosed embodiments may be configured to perform credit inquiries to provide a variety of banking arrangement options that may be used with an entity at a unique geographic location.

### BACKGROUND

A banking arrangement may include providing an individual or a business the ability to make a purchase using, for example, a loan or a line of credit or other pre-approved payment options. A variety of online and in-person purchases can be made using loan programs or pre-approved payment plans. However, traditional loan programs involve manual underwriting (e.g., an underwriter reviews documents that verify an individual's income and assets to determine if the individual is qualified to borrow). Thus, there is a need for more effective, more efficient, and more secure systems and methods for automating the credit decision process at a point of sale.

Further, the traditional approach to credit checks, often involving hard inquiries alone, has been associated with several drawbacks and limitations. Hard inquiries, which occur when a lender accesses an individual's credit report for evaluating creditworthiness, can have a negative impact on the person's credit score and raise concerns about credit-seeking behavior. There is a need to shift to automatic soft credit checks that mitigate the negative impact on credit scores, improving efficiency, and providing a more transparent and fair way of assessing creditworthiness for both lenders and customers.

Additionally, traditional payment process involves physical payment cards or cash. There is a need to eliminate physical payment cards or cash and provide a more secured method of transactions, reducing the complexity of the transaction process for both customers and merchants. The disclosure method incorporates the use of virtual payment cards stored in electronic wallets, thereby ensuring secure and hassle-free payments.

### SUMMARY

Embodiments consistent with the present disclosure provide systems, methods, and computer readable media generally related to issuing a banking arrangement for use with an entity at a unique geographic location. The disclosed systems and methods may be implemented using a combination of conventional hardware and software as well as specialized hardware and software, such as a machine constructed and/or programmed specifically for performing functions associated with the disclosed method steps. Consistent with other disclosed embodiments, non-transitory computer readable storage media may store program instructions, which are executed by at least one processing device and perform any of the steps and/or methods described herein.

Consistent with disclosed embodiments, systems, methods, and computer readable media for generating arrangement options for use with an entity at a unique geographic location are disclosed. The embodiments may include at least one processor. The processor may be configured to receive a unique token. The unique token may be associated with the entity at the unique geographic location. A first information associated with a requestor may be received. The first information may include one or more of a name, address, date of birth, and an identification number. The processor may be configured to perform, using the first information, a first inquiry. The first inquiry may include receiving a second information associated with the requestor. The second information may include a credit score. Furthermore, at least one processor may be configured to generate a variety of arrangement options. The variety of arrangement options may be determined using one or more of the first information and the second information. At least one processor may receive an input from the requestor, and the input may be indicative of a selected arrangement within the variety of arrangement options. At least one processor may be configured to perform a second inquiry. Furthermore, At least one processor may be configured to issue a selected arrangement based on the input from the requestor and the second inquiry. The selected arrangement may include a borrowed amount and repayment terms. The selected arrangement may be configured for use by the requestor with the entity at the unique geographic location.

In some embodiments, a method for obtaining and using an arrangement with an entity at a unique geographic location is provided. The method may include providing a unique token. The unique token may be associated with the entity at the unique geographic location. Embodiments of the present disclosure may include providing a first information associated with a requestor, and the first information may include one or more of a name, address, date of birth, and an identification number. Furthermore, embodiments may include receiving a variety of arrangement options. The variety of arrangement options may be determined using the first information. An input may be provided. The input may be indicative of a selected arrangement within the variety of arrangement options. A selected arrangement based on the provided input may be received. The selected arrangement may include a borrowed amount and repayment terms. The one-time arrangement may be used to make a purchase with the entity at the unique geographic location.

### BRIEF DESCRIPTION OF THE DRAWINGS

FIG. 1A is an illustration of an example of a user, or requestor, utilizing a user device to request a financing arrangement for use with an entity at a unique geographic location.

FIG. 1B is an illustration of an example of a user, or requestor, utilizing a user device to receive a financing arrangement for use with an entity at a unique geographic location.

FIG. 2 is a block diagram of an example of a computing device which may be employed in connection with disclosed embodiments.

FIG. 3 is a block diagram of an example of computing consistent with embodiments of the present disclosure.

FIG. 4 is an illustration of an example flowchart for issuing a one-time arrangement for use with an entity at a unique geographic location.

FIG. 5 is an illustration of an example flowchart for obtaining and using an arrangement with an entity at a unique geographic location.

FIG. 6 is an illustration of an example use of an arrangement in a purchase with an entity at a unique geographic location.

FIG. 7 is an illustration of an example flowchart for generating and deactivating a virtual payment card for use with an entity at a unique geographic location.

FIG. 8 is an illustration of an example of a financial institution transmitting to a user device a set of pricing tables for calculating a financing arrangement for use with an entity at a unique geographic location.

FIG. 9 is an illustration of an example of a user device interface window for receiving a financing arrangement for use with an entity at a unique geographic location.

FIG. 10 is an illustration of an example of a user device interface window for verifying a financing arrangement for use with an entity at a unique geographic location.

FIG. 11 is an illustration of an example of a user device interface window for accepting a financing arrangement for use with an entity at a unique geographic location.

### DETAILED DESCRIPTION

Examples of embodiments are described with reference to the accompanying drawings. In the figures, which are not necessarily drawn to scale, the left-most digit(s) of a reference number identifies the figure in which the reference number first appears. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

Unless specifically stated otherwise, as apparent from the following description, throughout the specification discussions utilizing terms such as “processing,” “calculating,” “computing,” “determining,” “generating,” “issuing,” “setting,” “configuring,” “selecting,” “defining,” “applying,” “obtaining,” “monitoring,” “providing,” “identifying,” “segmenting,” “classifying,” “analyzing,” “associating,” “extracting,” “storing,” “receiving,” “transmitting,” or the like, include actions and/or processes of a computer that manipulate and/or transform data into other data, the data represented as physical quantities, for example such as electronic quantities, and/or the data representing physical objects. The terms “computer,” “processor,” “controller,” “processing unit,” “computing unit,” and “processing module” should be expansively construed to cover any kind of electronic device, component or unit with data processing capabilities, including, by way of non-limiting example, a personal computer, a wearable computer, smart glasses, a tablet, a smartphone, a server, a computing system, a cloud computing platform, a communication device, a processor (for example, digital signal processor (DSP), an image signal processor (ISR), a microcontroller, a field programmable gate array (FPGA), an application specific integrated circuit (ASIC), a central processing unit (CPA), a graphics processing unit (GPU), a visual processing unit (VPU), and so on), possibly with embedded memory, a single core processor, a multi core processor, a core within a processor, any other electronic computing device, or any combination of the above.

The operations in accordance with the teachings herein may be performed by a computer specially constructed or programmed to perform the described functions.

As used herein, the phrase “for example,” “such as,” “for instance” and variants thereof describe non-limiting embodiments of the presently disclosed subject matter. Reference in the specification to features of “embodiments,” “one case,” “some cases,” “other cases” or variants thereof means that a particular feature, structure or characteristic described may be included in at least one embodiment of the presently disclosed subject matter. Thus, the appearance of such terms does not necessarily refer to the same embodiment(s). As used herein, the term “and/or” includes any and all combinations of one or more of the associated listed items. As used herein, the expression “at least one of . . . or” may include each listed item individually or any combination of the listed items. For example, the expression “at least one of A, B, or C” may include any of A, B, or C alone or any combination of A, B, and C (e.g., A+B, A+C, B+C, or A+B+C).

Features of the presently disclosed subject matter, are, for brevity, described in the context of particular embodiments. However, it is to be understood that features described in connection with one embodiment are also applicable to other embodiments. Likewise, features described in the context of a specific combination may be considered separate embodiments, either alone or in a context other than the specific combination.

In embodiments of the presently disclosed subject matter, one or more stages illustrated in the figures may be executed in a different order and/or one or more groups of stages may be executed simultaneously and vice versa. The figures illustrate a general schematic of the system architecture in accordance embodiments of the presently disclosed subject matter. Each module in the figures can be made up of any combination of software, hardware and/or firmware that performs the functions as defined and explained herein. The modules in the figures may be centralized in one location or dispersed over more than one location.

Examples of the presently disclosed subject matter are not limited in application to the details of construction and the arrangement of the components set forth in the following description or illustrated in the drawings. The subject matter may be practiced or carried out in various ways. Also, it is to be understood that the phraseology and terminology employed herein is for the purpose of description and should not be regarded as limiting.

The drawings in this document may not be to any scale. Different figures may use different scales and different scales can be used even within the same drawing, for example different scales for different views of the same object or different scales for the two adjacent objects.

Consistent with disclosed embodiments, “at least one processor” may constitute any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory. The memory may include a Random-Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

Reference will now be made in detail to example embodiments, discussed with regard to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures can be rearranged, combined, or divided without departing from the envisioned embodiments. Similarly, additional steps may be added or steps may be removed without departing from the envisioned embodiments. Thus, the materials, methods, and examples are illustrative only and are not intended to be necessarily limited.

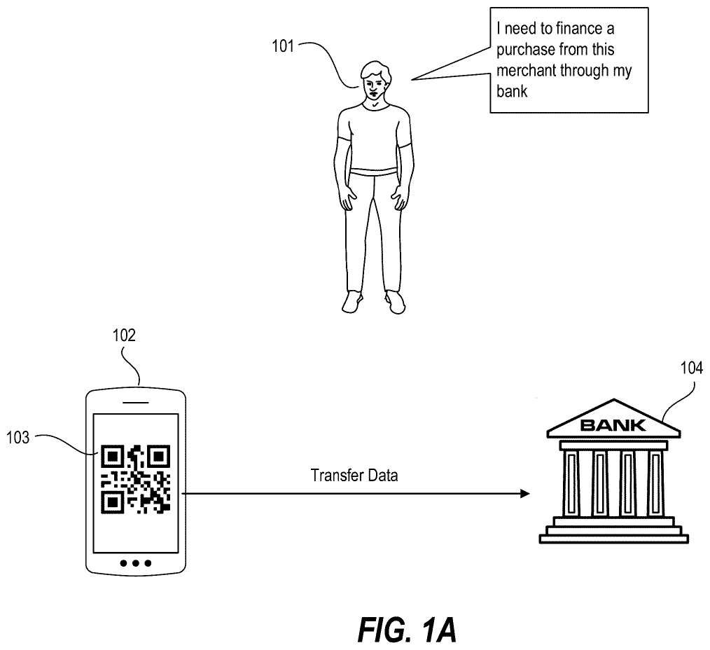

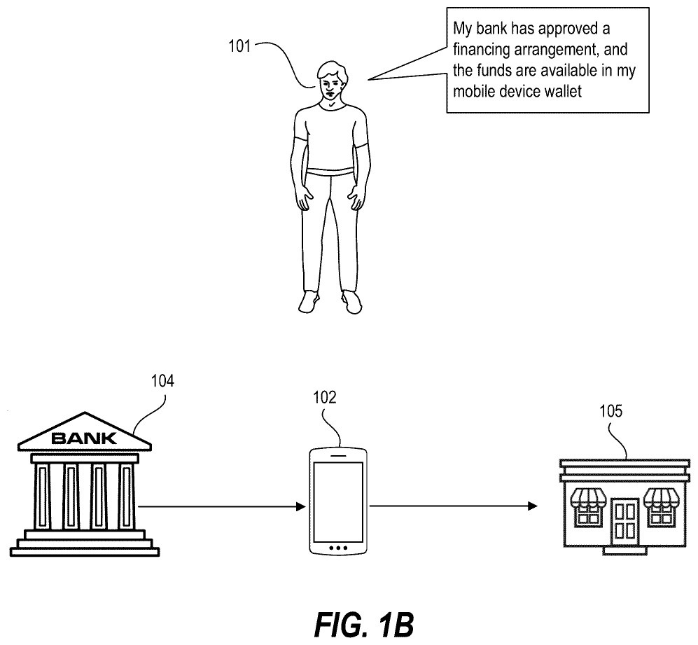

FIG. 1A is an illustration of a user, or requestor, 101 requesting a financing arrangement for use with an entity at a unique geographic location consistent with some embodiments. The requestor 101 may require a financing arrangement through a financial institution 104, such as a bank, for use with a purchase at a particular entity, such as a merchant. The requestor 101 may request a financing arrangement using a user device 102. In some embodiments, the requestor may utilize a camera associated with user device 102 to scan a QR code 103, or similar, specific to the particular entity at the unique geographic location. The QR code 103 may be generated, for example, in a point-of-sale (POS) device, i.e., a device used to make sales in person, associated with the particular entity at the unique geographic location.

Upon scanning the QR code 103, the user device 102 may transfer a unique token associated with the particular entity at the unique geographic location to a financial institution 104. The financial institution 104 may perform one or more inquiries related to the requested financing arrangement.

FIG. 1B is an illustration of a user, or requestor, 101 receiving a financing arrangement, consistent with some embodiments. The financial institution 104 may approve the requester for a variety of financing arrangement options for use with the particular entity at the unique geographic location based on the inquiries performed. The financial institution 104 may transmit to the user device 102 a representation of the variety of financial arrangement options. The requestor 101 may select a financing arrangement that conforms to the requestor's needs. Upon selection of a financing arrangement, a virtual payment card may be presented on user device 102. The requestor 101 may use the user device 102, via the user device's 102 mobile wallet or otherwise, to initiate payment with the particular entity 105 at the unique geographic location.

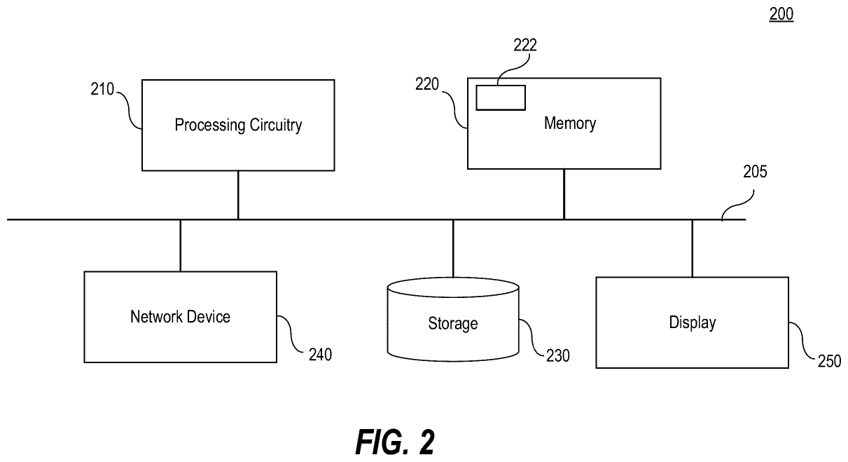

FIG. 2 is a block diagram of an example computing device 200 for generating a column and/or row oriented data structure repository, or similar, for data consistent with some embodiments. The computing device 200 may include processing circuitry 210, such as, for example, a central processing unit (CPU). The instructions executed by at least one processor may, for example, be pre-loaded into a memory integrated with or embedded into the controller or may be stored in a separate memory.

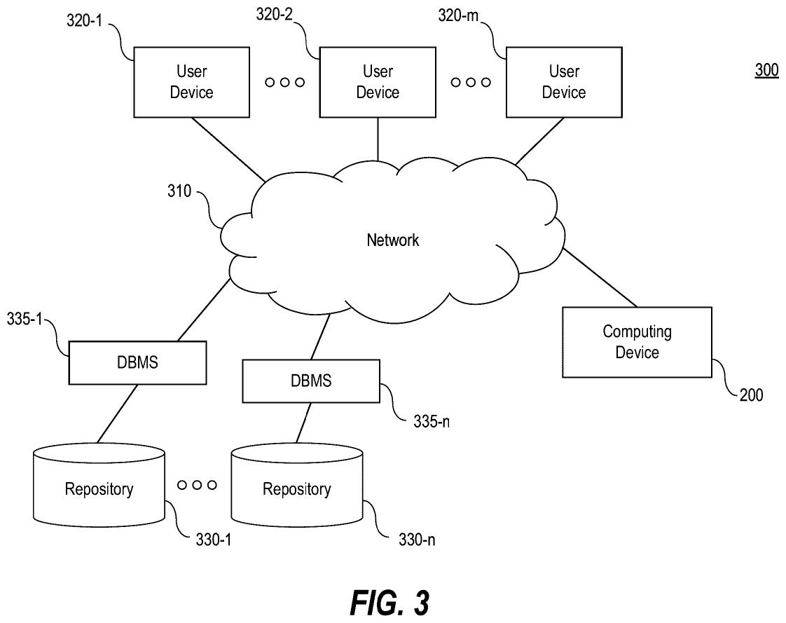

The memory 220 may further include a memory portion 222 that may contain instructions that when executed by the processing circuitry 210, may perform the method described in more detail herein. The memory 220 may be further used as a working scratch pad for the processing circuitry 210, a temporary storage, or otherwise storing information, as the case may be. The processing circuitry 210 may be further connected to a network device 240, such as a network interface card, for providing connectivity between the computing device 200 and a network, such as a network 310, discussed in more detail with respect to FIG. 3 below. The processing circuitry 210 may be further coupled with a storage device 230. The storage device 230 may be used for the purpose of storing data structures or data elements associated with the data structures. While illustrated in FIG. 2 as a single device, it is to be understood that storage device 230 may include multiple devices either collocated or distributed. As shown in FIG. 2, computing device 200 may include a display 250. Display 250 may be a computer screen, a phone screen, a tablet screen, or any other graphical user interface (GUI) or structure capable of displaying data.

The processing circuitry 210 and/or the memory 220 may also include machine readable media for storing software. “Software” as used herein refers broadly to any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, may cause the processing system to perform the various functions described in further detail herein.

FIG. 3 is a block diagram of computing architecture 300 that may be used in connection with various disclosed embodiments. The computing device 200, as described in connection with FIG. 2, may be coupled to network 310. The network 310 may enable communication between different elements that may be communicatively coupled with the computing device 200, as further described below. The network 310 may include the Internet, the world-wide-web (WWW), a local area network (LAN), a wide area network (WAN), a metro area network (MAN), and/or other networks capable of enabling communication between the elements of the computing architecture 300. In some disclosed embodiments, the computing device 200 may be a server deployed in a cloud computing environment.

One or more user devices 320-1 through user device 320-m, where ‘m’ in an integer equal to or greater than 1, referred to individually as user device 320 and collectively as user devices 320, may be communicatively coupled with the computing device 200 via the network 310. A user device 320 may be for example, a smart phone, a mobile phone, a laptop, a tablet computer, a wearable computing device, a personal computer (PC), a smart television, or the like. A user device 320 may include some or all of the components discussed with respect to device 200. A user device 320 may be configured to send to and/or receive from the computing device 200 data and/or metadata associated with a variety of elements associated with single data type column-oriented data structures, such as columns, rows, cells, schemas, and the like. In an embodiment, the user device 320 may be configured to read and execute a computer program, such as a mobile application.

One or more data repositories 330-1 through data repository 330-n, where ‘n’ in an integer equal to or greater than 1, referred to individually as data repository 330 and collectively as data repository 330, may be communicatively coupled with the computing device 200 via the network 310, or embedded within the computing device 200. Each data repository 330 may be communicatively connected to the network 310 through one or more database management services (DBMS) 335-1 through DBMS 335-n, where ‘n’ in an integer equal to or greater than 1. The data repository 330 may be for example, a storage device containing a database, a data warehouse, and the like, that may be used for storing data structures, data items, metadata, or any information, as further described below. In some embodiments, one or more of the repositories may be distributed over several physical storage devices, e.g., in a cloud-based computing environment. Any storage device may be a network accessible storage device, or a component of the computing device 200.

Embodiments of the present disclosure may include issuing an arrangement for use with an entity at a unique geographic location. As used herein, an entity may be a person, a plurality of people, or an organization engaged in providing a product, good, or service in exchange for compensation in the form of money or a monetary instrument (e.g., promissory note, check, etc.). An arrangement may include a loan, such as a short-term loan, or any other method of borrowing money from a bank or other money-lending entity. A one-time arrangement may be designated for use once. For example, a one-time arrangement may be used for a single purchase at a single entity, for example, a merchant, vendor, or the like. The one-time arrangement may no longer be available after use. Furthermore, the one-time arrangement may, in some embodiments, only be used with a single (or designated) entity or for a single (or designated) item or service. A geographic location may include a particular position on Earth and may be designated by, for example, an address or a combination of longitude and latitude of a particular place.

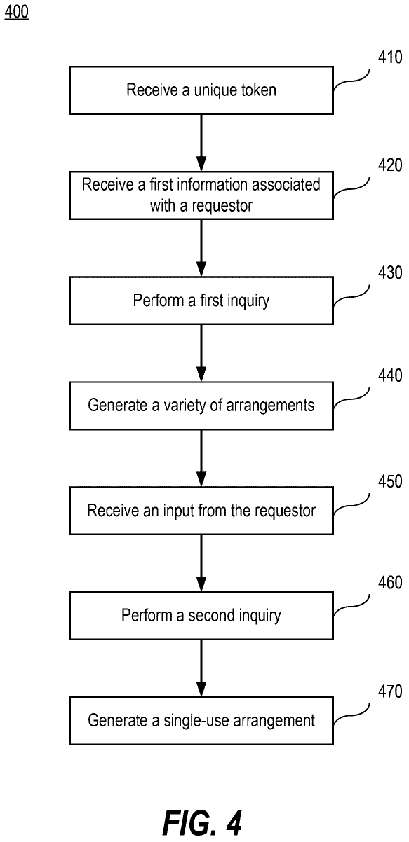

FIG. 4 is an illustration of a flowchart of an example method 400 for issuing a one-time arrangement for use with an entity at a unique geographic location from the perspective of a financial institution computing device. Disclosed embodiments may involve receiving a unique token, as shown in step 410 of FIG. 4. The unique token may be associated with the entity at the unique geographic location. For example, the unique token may include an indication of identify of the specific entity and/or the unique geographic location. In some embodiments, the unique token may be a Quick Response (QR) code, a bar code, an alphanumeric code, or similar. It is contemplated that the unique token may be any method or manner of identifying an entity at a unique geographic location such as, but not limited to, an identification code, address, or graphical representation. The unique token may be machine readable by, for example, a phone, a tablet, a computer, a camera, or other electronic device.

By associating a unique token specific to a unique geographic location, the security of the arrangement issuance system is improved. For example, in alternative systems, an entire brand, chain, or conglomerate of merchants may be associated with a common token. That is, the unique token associated with Acme Store's Austin, Texas location may be identical to that associated with Acme Store's Denver, Colorado location. Widespread use of a common token, however, provides an opportunity for a bad actor, having gained unauthorized access to the token, to impact many requestors and merchants. Continuing with the previous example, a bad actor having gained unauthorized access to the token associated with Acme Store's Austin, Texas location may, due to the use of a common token, also reach requestors and operations at Acme Store's Denver, Colorado location.

On the other hand, by issuing unique tokens to unique geographic entities, the extent to which a bad actor can inflict damage through gaining unauthorized access to one unique token is limited to one unique geographic location. That is, by differentiating the tokens associated with Acme Store's Austin, Texas and Denver, Colorado locations, a bad actor having gained unauthorized access to only one unique token is unable to reach both locations and both sets of requestors.

Disclosed embodiments may involve receiving a first information associated with a requestor, as shown in step 420 of FIG. 4. As used herein, a requestor may include any individual desiring to obtain an arrangement, such as a loan. The first information associated with the requestor may include the name of the requestor, the requestor's home address, the requestor's date of birth, the requestor's identification number, or any other information that may provide identification of the requestor. For example, the requestor's identification number may include a social security number (SSN) or a tax identification number (TIN). The first information may be useful in performing credit inquiries, such as soft credit inquiries (e.g., soft credit pulls) or hard credit inquiries (e.g., hard credit pulls). A soft credit inquiry may include the requesting and receipt of a credit report of an individual before the individual has applied for credit. A soft credit inquiry may be performed without affecting the individual's credit score. A hard credit inquiry may include the requesting and receipt of a credit report of an individual after the individual has applied for new credit. A hard credit inquiry may affect the individual's credit score when performed. Thus, by affecting an individual's credit score, a hard credit inquiry may influence the individual's ability to apply for and receive credit. For example, performing a hard credit inquiry to receive an individual's credit report may decrease the individual's credit score, and the decrease may impact the individual's ability to apply for and receive credit, such as in the form of loans, in the future.

When retrieving the first information associated with a requestor from a banking system, authentication and authorization may be needed. The requestor may send a request for an arrangement, via a mobile application, to the banking system using credentials like an API key or access token. The API key or access token may be specific to the user or application instance such as to identify the user or application instance. An API server may verify, based on the API key or access token, whether the requesting user or application is authorized to access the requested personal information.

Once authenticated and authorized, the mobile application may send a request to a service API, specifying the desired personal information to be retrieved. This request may typically include parameters such as the requestor's account number, unique identifier, or other details that uniquely identify the requestor whose information is being requested.

For example, the mobile application may invoke a service API that communicates with a database containing requestor information. The service API may respond to the mobile application by returning requestor information.

The API server may receive the request securely over the network using protocols like HTTPS. The API server may validate the request, ensuring it meets the required standards and includes the necessary parameters, for example, by validating an API key.

The service API may be a banking system's API server that retrieves the requested personal information from the relevant data sources, such as customer databases, account records, or transaction histories. The service API may gather the necessary data to fulfill the request and may generate a response in a structured format, such as JSON or XML. The response may contain the retrieved personal information, which may include details like the requestor's name, address, account balance, transaction history, or other relevant information.

Once the response is generated, the service API may securely deliver it back to the requesting application over the network, using the same secure protocol as the request. The response may include the retrieved personal information and appropriate status codes indicating the success or failure of the request. For example, a requestor may be presented, within the mobile application on the mobile device, with a failure message if the service API is unable to retrieve the requested information. Alternatively, upon successful completion of the request, the requestor may be presented with a success message accompanying the requested information.

Upon receiving the response, the mobile application may perform various tasks, such as data validation, transformation, or utilizing the information for generating reports, displaying account summaries, or enabling further actions within the application. For example, the mobile application may display the requested information (e.g., a name, home address, or social security number) on the mobile device and request that the requestor validate the information by interacting with the mobile application.

As shown in step 430 of FIG. 4, some embodiments may involve performing a first inquiry. The first inquiry may be performed, or enabled, by the first information associated with the requestor. For example, the first inquiry may be a soft credit inquiry, where a soft credit inquiry may be performed without impacting the credit score of the requestor. To perform a soft credit inquiry into an individual (or requestor), one or more of the name, address, date of birth, and identification number of the individual may be required. Furthermore, in some embodiments, the first inquiry may include receiving a second information associated with the requestor. The second information may include, for example, a credit score, a credit report, or any other indicator of the requestor's ability to request (or apply for) and receive credit.

Performing a soft credit inquiry into an individual (or requestor) may involve utilizing soft credit inquiries APIs. The APIs may facilitate the secure exchange of relevant data parameters, such as the requestor's personal information, from a financial institution to a consumer reporting agency, such as a credit bureau. These parameters may be used to perform a soft credit inquiry, which may be a preliminary assessment that may not have any lasting impact on the requestor's credit history.

During the soft credit inquiry process, the credit bureau system may generate a credit report or credit score based on the provided data parameters. However, unlike a hard credit inquiry, which occurs when an individual formally applies for credit, the soft credit inquiry may be performed without creating a record on the requestor's credit history. As a result, the soft credit inquiry may not impact the requestor's credit score.

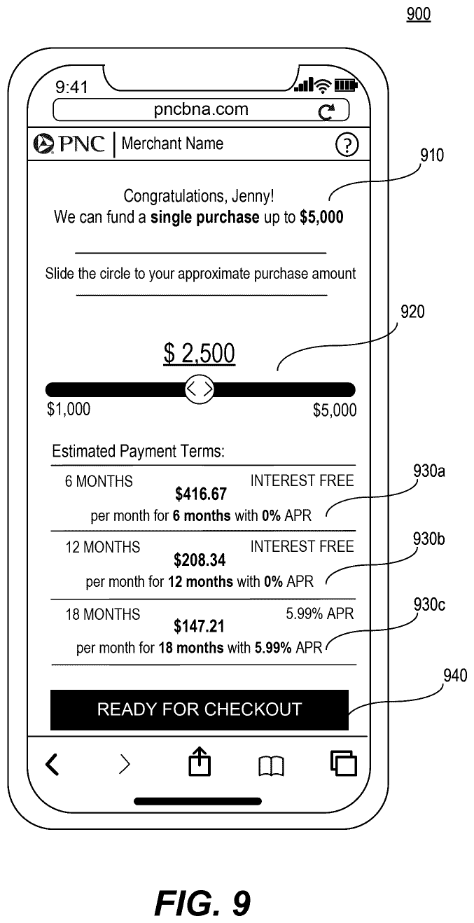

In some embodiments, a variety of arrangement options may be generated, as shown in step 440 of FIG. 4. For example, three different arrangement options with three different payment terms may be generated. The variety of arrangement options may include, for example, a $4,000 loan to be repaid over 12 months, over 24 months, or over 36 months. The variety of arrangement options may also vary with respect to, for example, loan amount, repayment interest rate, origination fee, down payment, collateral or any combination of the like. In one embodiment, the variety of arrangement options may include eligibility for a loan ranging from $50 to $5,000 in $50 increment, where each discrete increment may include various repayment options such as, but not limited to, over 12 months, over 24 months, over 36 months, or any other duration. For example, an arrangement option may be generated for a $100 loan to be repaid over a 12 month period with a 10.9 percent repayment interest rate. The repayment interest rate option(s), or other arrangement terms, may be determined based on an annual gross income of the requestor, and the annual gross income of the requestor may be included in one or more of the first information and the second information. The variety of arrangement options is discussed further with respect to FIG. 9.

The variety of arrangement options may be based on a maximum possible loan that the requestor may be eligible for. For example, it may be determined that the requestor is eligible for a loan that is up to $5,000. Thus, the variety of arrangement options may range from a lower bound (e.g., $50) to the maximum possible loan, $5,000. In this example, the requestor may be eligible for a variety of repayment options, such as over 12 months, 24 months, or 36 months. In some embodiments, the requestor may be eligible for more repayment options (e.g., over 12 months, 24 months, 36 months, and 48 months). In other embodiments, the requestor may be eligible for less repayment options (e.g., over 12 months and 24 months). The maximum possible loan that the requestor is eligible for may be determined by the credit score and credit history of the requestor.

Each arrangement may be associated with additional loan terms, such as payment amount, repayment interest rate (fixed or variable), grace periods for non-payment, or amount of time between payments, for example. The variety of arrangement options may include a variety of combinations of loan terms. For example, in some embodiments, an arrangement having a large loan balance and a long loan term may be associated with a high repayment interest rate as compared to an arrangement with a small loan balance and short loan term.

Furthermore, in some embodiments, the requestor may indicate a desired monetary value, and the generating of the variety of arrangement options may be further based on the monetary value. The desired monetary value may be, for example, an amount of money desired for use in a purchase, or a borrowed amount. For example, the requestor may indicate that they would like to take out a loan of $4,000. In this case, a variety of arrangement options may be generated, where the variety of arrangement options each include a loan balance of desired monetary value (i.e., $4,000). A variety of loan terms, such as repayment interest rate, loan duration, and grace periods may be included in the generated arrangement options.

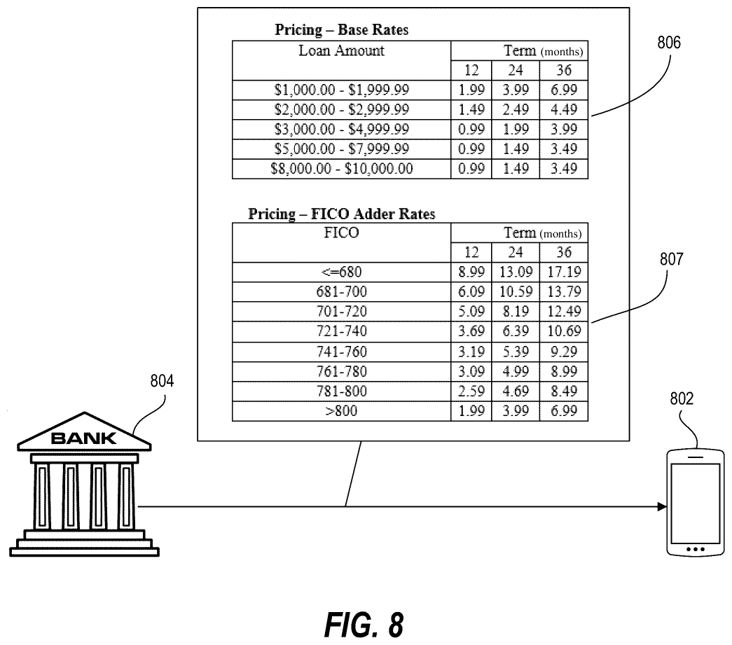

Additionally, or alternatively, in some embodiments, a third information associated with the requestor may be generated. The third information may include a pricing table. A pricing table may include, for example, a representation of the loan amounts that the requestor may be eligible for in conjunction with the repayment options that the requestor is eligible for. Pricing tables are discussed further with respect to FIG. 8.

Disclosed embodiments may include receiving an input from the requestor, as shown in step 450 of FIG. 4. The input from the requestor may be indicative of a selected arrangement selected by the requestor from the variety of arrangement options presented to the requestor. For example, the selected arrangement may be a $4,000 loan (e.g., borrowed amount) to be repaid over 12 months (e.g., repayment terms). The requestor, or user, may input their selected arrangement by selecting a button, selecting a presented value, typing a desired value(s), or any other method of interacting with a system. This is described in further detail with respect to FIG. 9.

In some embodiments, and as shown in step 460 of FIG. 4, a second inquiry may be performed. The second inquiry may include a soft credit inquiry or a hard credit inquiry. For example, the second inquiry may include a hard credit inquiry (or hard credit pull), and the hard credit inquiry may affect the requestor's credit score.

Furthermore, in some embodiments, and as shown in step 470 of FIG. 4, a one-time arrangement may be issued based on the input from the requestor and the second inquiry. As an example, the one-time arrangement may reflect a selected arrangement. Continuing the example above, the selected arrangement may be a $4,000 loan to be repaid over 12 months. In this example, the $4,000 may be the borrowed amount and the 12 months may be the repayment term. In some embodiments, the second inquiry may include confirming that the requestor is eligible for the selected arrangement.

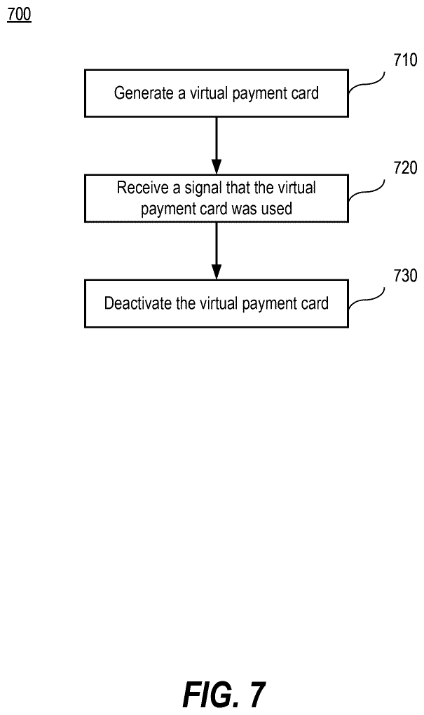

Additionally, or alternatively, the one-time arrangement may be configured for use by the requestor with the entity at a unique geographic location. For example, the one-time arrangement may be restricted for use at only one location or merchant, where the only one location or merchant is designated or identified by the unique token of step 410 of FIG. 4. Furthermore, in some embodiments, the one-time arrangement may be configured to only be used once. Thus, once a purchase is made with the one-time arrangement, the one-time arrangement may be unable to be used again in, for example, another purchase. This is explained further with respect to FIG. 7.

In some embodiments, the one-time arrangement may be presented as a digital card. For example, the digital card may comprise the details of any sort of payment card, for example, a debit or credit card. The digital card may be associated with a card number or primary account number (PAN), an expiration date, and a card security code, as examples. The one-time arrangement may be presented as a digital card and imported into, for example, a digital (or mobile) wallet such as Apple Wallet® or Google Wallet®. This may allow the requestor to use the digital card in the same manner as any debit or credit card. For example, a front-end credit card processor, which typically authorizes credit card transaction, may recognize the arrangement as a credit card issued by the financial institution. As such, the arrangement may be processed by the merchant's credit card payment terminal. Accordingly, in some embodiments, the requestor may use the digital card by tapping the requestor's user device on the merchant's contactless payment terminal. The digital card be processed like a credit card, and merchant may not need any additional equipment to accept the arrangement. The arrangement, represented by the digital card, may be used in an online purchase or an in-person purchase.

Additionally, or alternatively, the arrangement may be valid for a designated duration of time. For example, the arrangement may be valid for 24 hours. As another example, the arrangement may be valid for 2 hours. It is contemplated that the arrangement may remain valid for any suitable duration of time, or time period.

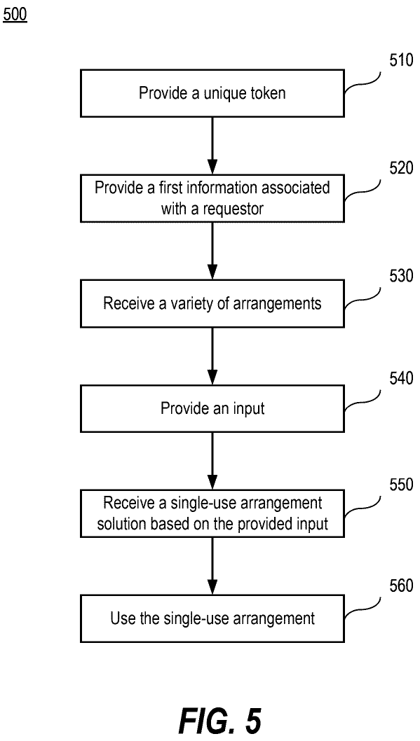

FIG. 5 is an illustration of an example flowchart of a method 500 for receiving and using a one-time arrangement with an entity at a unique geographic location from the perspective of a user device. The one-time arrangement may be a short-term loan.

A unique token may be associated with the entity at the unique geographic location. The unique token may be represented by a QR code, barcode, or similar. In some embodiments, the QR code may be displayed on a sign or screen associated with the particular entity at a unique geographic location. In other embodiments, the QR code may be displayed on a point of sale (POS) system, including self-checkout POS systems and POS systems operated by a cashier. A requestor may scan the QR code with the camera associated with the requestor's user device. In some embodiments, scanning the QR code will prompt an application to load on the user device. In other embodiments, scanning the QR code will prompt the user device to navigate to a specific internet address.

As shown in step 510 of FIG. 5, the user device may provide the unique token to a computing device associated with a financial institution. For example, the user device may transmit the unique token to a financial institution server via a data network. The unique token may identify the entity at a unique geographic location to the financial institution.

In some embodiments, and as shown in step 520 of FIG. 5, the user device may transmit a first information associated with a requestor to the financial institution. The first information may include one or more of a name, address, date of birth, and an identification number. The first information may be sufficient for the financial institution to uniquely identify the requestor. The financial institution may utilize the first information perform a credit check on the requestor.

The unique token and the first information may provide the financial institution with sufficient information to calculate a variety of arrangement options. For example, using first information, the financial institution may determine the requestor's credit score, whether the requestor has a prior or current relationship with the financial institution, and the requestor's annual gross income. Using the unique token associated with the entity at the unique geographic location, the financial institution may determine the name of the merchant, the types of goods or services the merchant deals in, and whether customers of the merchant have historically defaulted on loans, as examples. In some embodiments, the entity at the unique geographic location may partner with the financial institution to provide arrangement options with preferential terms.

The financial institution may calculate and send a variety of arrangement options to the user device. In some embodiments, the financial institution may use the unique token and first information to generate one or more pricing tables, which are then provided to the user device for local calculation of the variety of arrangement options.

As shown in step 530 of FIG. 5, a variety of arrangement options may be received by the user device. The variety of arrangement options may be depicted in a window of the application or website, for example, running on the user device. This is discussed in more detail with respect to FIG. 9.

In some embodiments, the requestor may provide an input, as shown in step 540 of FIG. 5, using a control element, such as a text box, slider, or button, provided in the window. The input may be indicative of a selected arrangement selected from the variety of arrangement options presented to the requestor. The user device may transmit the input to a financial institution computing system. This may prompt the financial institution to issue the arrangement.

Furthermore, as shown in step 550 of FIG. 5, a one-time arrangement based on the provided input may be received from the financial institution computing system. The one-time arrangement may include a borrowed amount and repayment terms. In some embodiments, the repayment terms may be calculated based on an arrangement duration and the borrowed amount may be selected by the requestor. As explained above, the arrangement may be presented as a digital card and imported into, for example, a digital (or mobile) wallet such as Apple Wallet® or Google Wallet®.

Furthermore, as shown in step 560 of FIG. 5, the requestor may use the one-time arrangement to make a purchase with the entity at the unique geographic location. For example, the requestor may tap the user device on a contactless payment terminal associated with the entity at the unique geographic location to trigger payment in the same manner as the requestor would tap a debit or credit card.

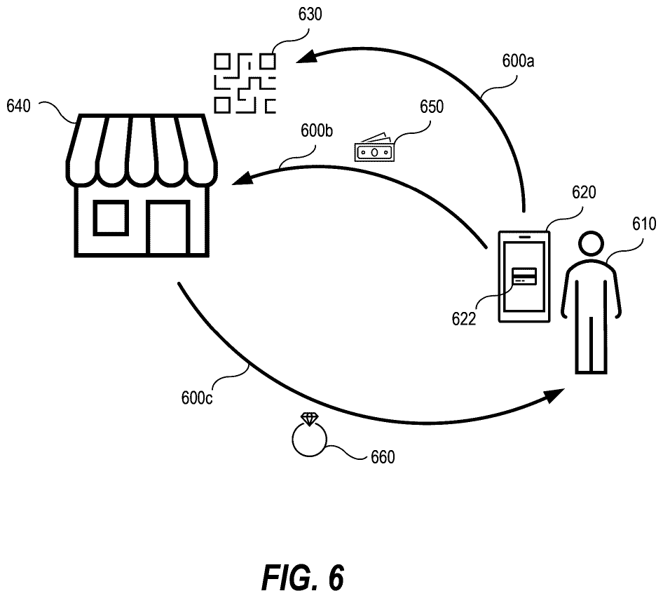

FIG. 6 is an illustration of an example use of an arrangement in a purchase with an entity at a unique geographic location. As shown in FIG. 6, a requestor 610 may use a mobile device 620 to scan a quick response (QR) code 630 associated with a merchant 640 via scanning process 600a. Merchant 640 may be an entity at a unique geographic location. QR code 630 may include information associated with merchant 640 such as, but not limited to, the merchant's name, address, item catalogue, and/or pricing catalogue. The scanning process 600a of QR code 630 may allow requestor 620 to begin the process of obtaining and using a one-time arrangement, such as process 500 of FIG. 5. In some embodiments, process 500, or any other automated credit approval process, may be performed using software executed entirely on, for example, mobile device 640. Furthermore, in some embodiments, at least one of a passcode, biometric data, or other form of identification validation may be processed before process 500 may begin. Upon receiving the one-time arrangement, as shown in step 550 of FIG. 5, requestor 610 may use the one-time arrangement to make a purchase via transfer of funds 600b with merchant 640. As shown in FIG. 6, the one-time arrangement may be represented by a digital card 622. Digital card 622 may be used to make a purchase via transfer of funds 600b with merchant 640, where the purchase is made using the borrowed funds 650. As a result, requestor 610 may purchase, via transfer of funds 600b, and receive, via transfer of goods or services 600c, a good or service 660. It is contemplated that borrowed funds 650 may include any amount and is not limited to any range or monetary value. As an example, borrowed funds 650 may be $50,000, and may be used to purchase a car. As another example, borrowed funds 650 may be $6,000, and may be used to purchase jewelry.

In some embodiments, digital card 622 may be generated using a mobile device application on requestor 610's end, based on the one-time arrangement selected by requestor 610.

After digital card 622 is generated, it may be stored within the mobile device's electronic wallet, which may utilize encryption and other security measures to protect the card's information. In some embodiments, digital card 622 may be associated with a unique identifier and may be displayed within the mobile device's app, presenting a barcode or QR code.

In some embodiments, a product offered by merchant 640 may be scanned by mobile device 620. For example, the product offered by merchant 640 may be the unique token of, for example, steps 410 and 510 in processes 400 and 500, respectively. The variety of arrangement options may be generated based on a price associated with the product offered by merchant 640.

Additionally, or alternatively, in some embodiments, requestor 610 may be geolocated via, for example, a built-in global positioning system (GPS) of mobile device 620. In this case, a QR code 630 may not be required in the process 500 of obtaining and using the one-time arrangement. For example, merchant 640 may automatically be located when requestor 610 is at or near merchant 640 by comparing the GPS location of the user device with the known GPS coordinates of merchant 640. The variety of arrangement options, such as those received in step 550 of FIG. 5, may automatically be generated for requestor 610 based on the vicinity of requestor 610 (and mobile device 620) to merchant 640 and the first information previously provided to disclosed systems and methods by requestor 610. The variety of arrangement options may be further based on deals or sales provided by merchant 640 at that point in time. In some embodiments, an alerting function may be implemented. The alerting function may provide an alert to requestor 610 using mobile device 620 when requestor 610 is at or near merchant 640.

In some embodiments, when requestor 610 is ready to make a purchase in the merchant store, requestor 610 may approach a point of sale device in the store. The requestor may present the digital card from their mobile device by opening the app and displaying the barcode or QR code on the mobile device's screen. Additionally or alternatively, Near Field Communication (NFC) technology can be used to transmit the digital card's information wirelessly to the point of sale device. The point of sale device may receive information of digital card 622 from requestor 610's mobile device. The point of sale device may validate the authenticity and validity of the digital card by verifying the unique identifier, checking for any expiration or usage restrictions, and confirming that the digital card corresponds to the unique geographic location and the one-time arrangement.

Upon successful verification, the point of sale device may send a signal or confirmation indicating that the digital card has been used for the transaction. This signal may confirm the payment and authorize the completion of the purchase. The point of sale device may communicate with a secure payment gateway to process the transaction, deduct an allocated amount of funds from the requestor's account, and update merchant 640's records accordingly.

In some embodiments, once the transaction is completed, digital card 622 may be deactivated to prevent any further use. Deactivation may occur automatically, where digital card 622 is removed from the mobile device's app or marked as inactive, or through manual intervention by the requestor 610 or merchant 640. This ensures the one-time nature of a one-time arrangement, enhances security, and prevents unauthorized usage of digital card 622.

FIG. 7 is an illustration of a flowchart of an example method 700 for completing payment using a virtual payment card. Disclosed embodiments may involve generating a virtual payment card, as shown in step 710 of FIG. 7.

Based on the arrangement, a digital card may be generated and be added to a mobile application (e.g., wallet app) that incorporates a Software Development Kit (SDK). For example, the banking server may generate a payment card number, a card security code, and an expiration date based on the one-time arrangement. In some embodiments, the digital card may be represented by a token that corresponds to the digital card. The token may include card information, such as, card number, passwords, codes, and the amount of transaction (e.g., borrowed amount). Tokenization may be used as a security feature to prevent the dissemination of the card number and details, such that a secure token is stored and transmitted in place of the card number. Accordingly, the digital card, represented by the token, may be used to perform secure transactions.

Disclosed embodiments may include receiving a signal from the point of sale (POS) device at the unique geographic location indicating that the virtual payment card was used by the requestor in the entity at the unique geographic location input from the requestor, as shown in step 730 of FIG. 7. When a requestor wishes to make a transaction at a point of sale device, the requestor may initiate the transaction request using the mobile wallet application with the stored digital card. The mobile wallet application may transmit the secure token to the POS device, indicating the intention to use the stored digital card for the transaction. Upon receiving this request, the POS device may encrypt and transmit the received card information, transaction amount, and merchant identifier to a financial institution computing system. The financial institution computing system may evaluate the transaction details and send an authorization response back to the POS device. The authorization response may be encrypted with secured communication. Simultaneously, the financial institution computing system may also transmit the authorization response to the mobile wallet application.

Disclosed embodiments may include deactivating the virtual payment card, as shown in step 750 of FIG. 7. After the transaction is completed, the system may deactivate the virtual payment card to ensure that it cannot be further used. By deactivating the virtual payment card, the system eliminates any possibility of unauthorized or fraudulent transactions associated with that specific card. In some embodiments, the virtual payment card may be deleted from the mobile application.

The disclosed embodiments may include a plurality of user device interface windows that may be provided by an application executed on a user device, such as a smart phone, a mobile phone, a laptop, a tablet computer, a wearable computing device, a personal computer (PC), a smart television, or the like. In other embodiments, the user device interface window may be provided by a website running in an internet browser of the user device.

FIG. 8 is an illustration of an example of a financial institution transmitting to a user device a set of pricing tables for calculating a financing arrangement for use with an entity at a unique geographic location. In the embodiment disclosed in FIG. 8, financial institution 804 may transmit base pricing table 806 and adder pricing table 807 to user device 802.

One or more of base pricing table 806 and adder pricing table 807 may be specific to each requestor depending on, for example, the requested loan amount. For example, in base pricing table 806, loan amounts in column 1 correspond to base interest rates in columns 2, 3, and 4 depending on the associated loan term. In some embodiments, base pricing table 806 and adder pricing table 807 may be implemented using any of a variety of data structures, such as an array, an associative array, a linked list, a binary tree, a balanced tree, a heap, a stack, a queue, a set, a hash table, a record, a tagged union, ER model, and a graph.

Further, one or more of base pricing table 806 and adder pricing table 807 may be specific to each requestor depending on, for example, the requestor's credit history. For example, adder pricing table 807 illustrates a pricing table in which FICO credit scores (a measure of consumer risk) in column 1 correspond to adder interest rates in columns 2, 3, and 4 depending on the associated loan term. In some embodiments, the repayment interest rate associated with the arrangement may be the base interest rate plus the adder interest rate.

Furthermore, in some embodiments, base pricing table 806 and adder pricing table 807 may allow for an interactive user experience. For example, within the user interface on user device 802, the requestor may view arrangement options by, for example, sliding an activatable slider, pressing an activatable button, or any other form of viewing a plurality of options on the display of the user device. In some embodiments, the user input may present a slider, such as that embodiment by element 920 in FIG. 9, that changes an anticipated arrangement amount that is provided as an input by the requestor. As the requestor adjusts the input in the user interface, arrangement options may be determined using one or more of base pricing table 806 and adder pricing table 807. The user interface in described in more detail with respect to FIGS. 9, 10, and 11.

For example, base pricing table 806 and adder pricing table 807 may be stored in the memory of the user device. As the requestor adjusts the input in the user interface, the user device may, utilizing the tables or data structures stored in local memory, automatically calculate arrangement details, such as interest rate, based on the current user input.

In some embodiments, pricing tables may be specific to a unique geographic location or a group of unique geographic locations. For example, the pricing tables associated with one or more unique geographic locations may provide preferential rates for arrangements. Accordingly, the pricing tables may reflect discounts negotiated between the financial institution and merchants, whether at the specific location, region, nation, or global level. In one example, Acme Store's Austin, Texas location has negotiated a 0.5% rate discount with the financial institution, and requestors, having scanned with unique token at Acme Store's Austin, Texas location, may receive pricing tables reflecting the 0.5% rate discount.

Some embodiments may further include product-specific discounts. By receiving a SKU number associated with a product from the requestor or merchant, the identity of the specific product for which the arrangement has been requested may be determined, for example, by accessing the merchant's CRM database. The pricing tables may, therefore, be associated with the specific product. Accordingly, the pricing tables may reflect discounts negotiated between the financial institution and merchants, suppliers, or manufacturers at the product level. In one example, Acme Manufacturing Co. has negotiated a 0.5% rate discount with the financial institution for its Acme V1 product. Requestors having scanned a unique token and entered the SKU number associated with the Acme V1 product receive pricing tables reflecting the 0.5% rate discount.

Additionally, in some embodiments, unique tokens specific to unique products may be involved. Here, pricing tables may be specific to the unique product based on the unique token alone, and the pricing tables associated with one or more unique products may thus provide preferential rates for arrangements.

In some embodiments, pricing tables may reflect discounts associated with a unique geographic location and a unique product. Continuing the above examples, requestors having scanned with unique token at Acme Store's Austin, Texas location and entered the SKU number associated with the Acme V1 product may receive pricing tables reflecting the 0.5% rate discount negotiated by Acme Store's Austin, Texas location and the 0.5% discount negotiated by Acme Manufacturing Co., for a full discount of 1.0%.

The generation of pricing tables may, in some embodiments, allow for accelerated calculation of arrangement options on the local device. For example, the pricing tables may be generated and sent to the user device prior to the requestor interacting with the user interface. Thus, as the requestor requests a variety of arrangement options having a specific arrangement amount, the user device processor does not have to transmit the arrangement amount and wait to retrieve rates calculated by a remote server. Instead, the processor may present already calculated or determined arrangement options, based on the pricing table. This may reduce the processing power required by the mobile device to generate the variety of arrangement options and decrease the latency of presenting the variety of arrangement options to the requestor, thus increasing efficiency of the system. Additionally, by not relying on remote computing to calculate, for example, rates associated with the variety of arrangement options, it may not be necessary to transmit or receive individual arrangement detail calculations over a network. Instead, the pricing tables may be received by the mobile device in a single transmission, for example, when the requestor scans the QR code. This may reduce mobile data usage that the requestor may otherwise be charged for.

FIG. 9 is an illustration of an example of a user device interface window 900 for receiving a financing arrangement for use with an entity at a unique geographic location. The user device may present user device interface window 900 after the requestor scans a QR code associated with a particular entity and upon receiving a variety of arrangement options from a financial institution. The user device interface window 900 may include a reply message 910 that indicates whether the requestor has been approved for a variety of arrangement options. In some embodiments, the reply message 910 may include basic details of the variety of approved arrangement options such as the maximum amount of the variety of approved arrangement options.

The user device interface window 900 may further include a slider 920 for selection of a specific arrangement amount. For example, FIG. 9 illustrates a slider 920 for the selection of a specific arrangement amount ranging between $1,000 and $5,000. The requestor may slide the indicator between $1,000 and $5,000, for example, to select an approximate purchase amount.

The user device interface window 900 may further include estimated arrangement details for the specific arrangement requested using slider 920. For example, for the selected arrangement amount, the user device interface 900 may display estimated payment terms 930a-c for a variety of arrangement options including, for example, a $2,500 loan to be repaid over 6 months (930a), over 12 months (930b), or over 18 months (930c). In some embodiments, the requestor may be presented with preferential interest rates, such as 0% APR, for certain arrangement options. Once the requestor has selected an arrangement amount and reviewed the estimated payment terms for the variety of arrangement options, the requestor may submit the arrangement amount by pressing a “Ready for Checkout” button 940.

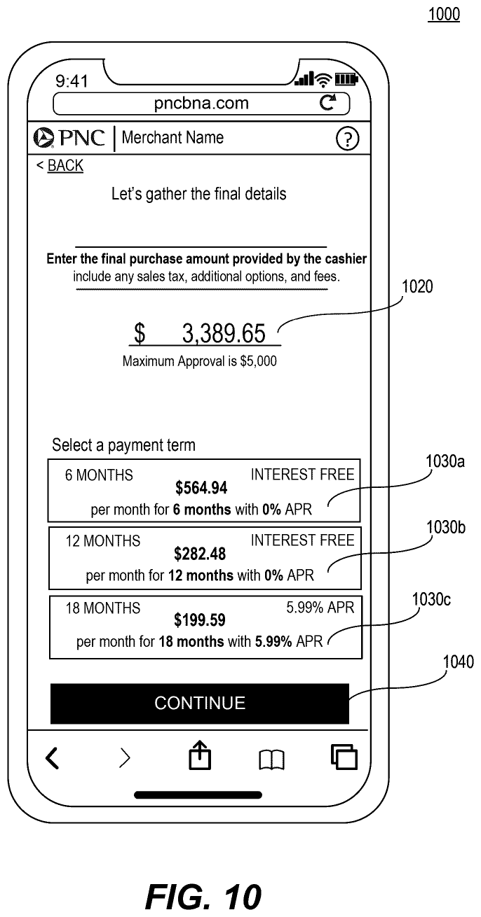

FIG. 10 is an illustration of an example of a user device interface window 1000 for verifying a financing arrangement for use with an entity at a unique geographic location. The user device may present user device interface window 1000 following the requestor's submission of the arrangement amount in FIG. 9. User device interface window 1000 may include an input box 1020 for the manual input of a final purchase amount. Alternatively, in some embodiments, the final purchase amount may be automatically populated. The user device interface window 1000 may further include a variety of arrangement options 1030a-c of an amount equal to the final purchase amount. For example, for the selected arrangement amount, the user device interface window 1000 may display estimated payment terms 1030a-c for a variety of arrangement options including, for example, an arrangement to be repaid over 6 months (1030a), over 12 months (1030b), or over 18 months (1030c). In some embodiments, the requestor may be presented with preferential interest rates, such as 0% APR, for certain arrangement options.

The user device interface window 1000 may provide for the selection of one of the displayed arrangement options. For example, the requestor may choose from one of 1030a, 1030b, or 1030c, by pressing on the arrangement option that best fits the requestor's needs. Once the requestor has selected an arrangement option, the requestor may proceed to the terms and conditions by pressing a “continue” button 1040.

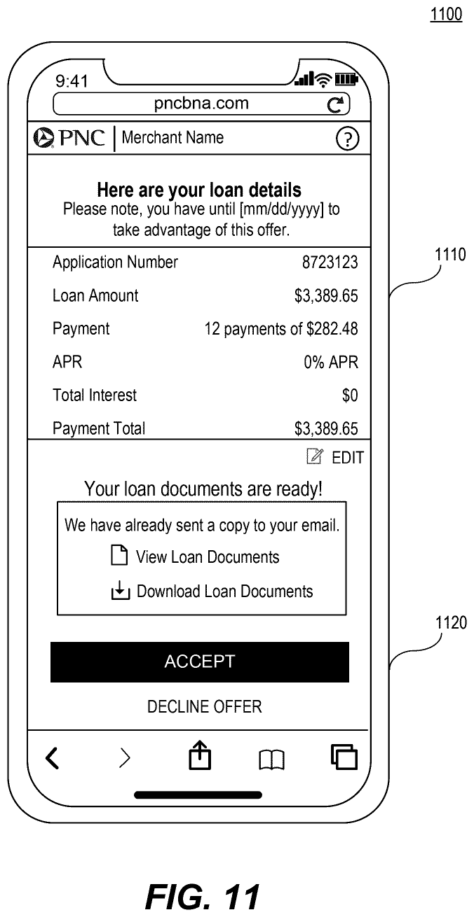

FIG. 11 is an illustration of an example of a user device interface window 1100 for accepting a financing arrangement for use with an entity at a unique geographic location. The user device interface window 1100 may comprise an arrangement offer including a detailed summary 1110 of the terms of the selected arrangement option. After reviewing the summary 1110, the requestor may accept or decline the arrangement offer by pressing, in acceptance area 1120, either the “accept” or “decline offer” button, respectively. After accepting the arrangement offer, the requestor may be presented with a virtual payment card (not pictured) for payment of the final purchase amount.

Embodiments of the present disclosure may provide a fully automated loan processing system with automatic credit decisions. Thus, disclosed embodiments may eliminate any manual underwriting aspects. Additionally, or alternatively, embodiments of the present disclosure may provide a point-of-sale loan product that does not require a revolving line of credit for a credit card, downloading an application for applying for a loan, or any other technique used in traditional systems and methods for generating loans or other arrangements.

The automated loan processing system, or automated credit approval, may include an initial soft credit inquiry followed by a hard credit inquiry. Both inquiries may be supplemented by a third inquiry to see whether the requestor has applied for any buy-now-pay-later plans or other forms of loan purchases within a duration of time (e.g., the past 30 days). This may allow the system to capture loans that have not yet been reported by, for example, credit bureaus, as credit bureaus may traditionally operate on a delay of, for example, 30 days. The combination of the soft credit inquiry followed by the hard credit inquiry supplemented by the third inquiry may allow the system to be fully automated and provide accurate and improved arrangements options or loan options. The third inquiry may occur at any time, such as, for example, before the first inquiry, during the first inquiry, after the first inquiry, before the second inquiry, during the second inquiry, or after the second inquiry. Furthermore, in some embodiments, the combination of the three inquiries as discussed above may provide a system and method to reduce fraud.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally comprise a “network” or a “computer network.”

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the disclosed embodiments. Further combinations of the above features and implementations are also considered to be within the scope of some embodiments or implementations.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Systems and methods disclosed herein involve unconventional improvements over conventional approaches. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

It is appreciated that the above described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units can be combined as one module or unit, and each of the above described modules/units can be further divided into a plurality of sub-modules or sub-units.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of embodiments disclosed herein. It is intended that the specification and examples be considered as example only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It will be appreciated that the embodiments of the present disclosure are not limited to the exact construction that has been described above and illustrated in the accompanying drawings, and that various modifications and changes may be made without departing from the scope thereof.

Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Computer programs based on the written description and methods of this specification are within the skill of a software developer. The various programs or program modules can be created using a variety of programming techniques. One or more of such software sections or modules can be integrated into a computer system, non-transitory computer readable media, or existing software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

What is claimed is:

1. A non-transitory computer readable medium containing instructions that, when executed by at least one processor, cause the at least one processor to generate a variety of arrangement options for use with an entity at a unique geographic location, the operations comprising:
providing a unique token at the unique geographic location, wherein the unique token is associated with the entity at the unique geographic location;
receiving a request for an arrangement, wherein the request is transmitted from a mobile device associated with a requestor;
querying a first database for a first information associated with the requestor;
receiving the first information associated with the requestor, wherein the first information includes one or more of a name, address, date of birth, and an identification number;
querying, using the first information associated with the requestor, a second database;
receiving a second information associated with the requestor from the second database;
generating the variety of arrangement options, wherein the variety of arrangement options is determined using one or more of the first information, the second information, and the unique token;
presenting the variety of arrangement options to the requestor;
receiving an input from the requestor, wherein the input is indicative of a selected arrangement within the variety of arrangement options;
querying, using the first information associated with the requestor, a third database;
receiving a third information associated with the requestor from the third database;
issuing the selected arrangement based on the input from the requestor and the third information, wherein the selected arrangement includes a borrowed amount and repayment terms, and wherein the selected arrangement is issued for use by the requestor with the entity at the unique geographic location.

2. The non-transitory computer readable medium of claim 1, wherein the first database is a collection of requestor account data.

3. The non-transitory computer readable medium of claim 1, wherein the selected arrangement has a term of 12 months or less.

4. The non-transitory computer readable medium of claim 1, wherein the second database is associated with a credit collecting organization.

5. The non-transitory computer readable medium of claim 1, wherein the second information is a measure of the requestor's ability to obtain goods or services before payment.

6. The non-transitory computer readable medium of claim 1, wherein the third database is associated with a credit collecting organization.

7. The non-transitory computer readable medium of claim 1, wherein the third information is measure of the requestor's ability to obtain goods or services before payment.

8. The non-transitory computer readable medium of claim 1, the operations further comprising generating a data structure associated with the requestor, wherein the data structure represents at least one table, and wherein the at least one table is determined using one or more of the first information and the second information.

9. The non-transitory computer readable medium of claim 8, wherein receiving the data structure prompts generating the variety of arrangement options.

10. The non-transitory computer readable medium of claim 8, wherein the variety of arrangement options are generated further based on the at least one table.

11. The non-transitory computer readable medium of claim 1, wherein the generating the variety of arrangement options is further based on a monetary value designated by the requestor.

12. The non-transitory computer readable medium of claim 1, wherein the selected arrangement is presented as a virtual card.

13. The non-transitory computer readable medium of claim 12, wherein the virtual card is used for one of an online transaction and an in-person transaction.

14. The non-transitory computer readable medium of claim 1, the operations further comprising:
generating a virtual card based on the selected arrangement, wherein the virtual card is configured for the requestor to use in the entity at the unique geographic location;
receiving a signal from a device at the unique geographic location indicating that the virtual card was used by the requestor in the entity at the unique geographic location; and
deactivating the virtual card.

15. A system for issuing an arrangement for use with an entity at a unique geographic location, the system comprising:
at least one processor configured to:
receive, from a mobile device, a unique token, wherein the unique token is linked to the entity at the unique geographic location;
receive, from the mobile device, a first data associated with a requestor, wherein the first data includes one or more of a name, address, date of birth, and an identification number;
query, using the first data, a first database for a second data associated with the requestor;
receive the second data associated with the requestor, wherein the second data includes a credit score;
generate a data structure comprising at least one table based on one or more of the unique token, the first data, and the second data, wherein the table contains information suitable to generate a variety of arrangement options;
transmit the data structure to the mobile device;
receive, from the mobile device, an input from the requestor, wherein the input is indicative of a selected arrangement;
query, using the first data, a second database for a third data associated with the requestor;
receive, from the second database, the third data associated with the requestor, wherein the third data includes a credit score;
issue the selected arrangement based on the input from the requestor and the third data, wherein the selected arrangement is for use by the requestor with the entity at the unique geographic location.

16. The method of claim 15, wherein the selected arrangement is in the form of a virtual card stored in a wallet associated with the mobile device.

17. A system for receiving an arrangement for use with an entity at a unique geographic location, the system comprising:
at least one processor configured to:
receive, at a mobile device, a unique token, wherein the unique token is linked to the entity at the unique geographic location;
transmit, from the mobile device, the unique token to a computing device associated with a financial institution;
transmit, from the mobile device, a first data to a computing device associated with the financial institution, wherein the first data includes one or more of a name, address, date of birth, and an identification number;
receive, from the computing device associated with the financial institution, a data structure comprising at least one table, wherein the at least one table contains information suitable to generate a variety of arrangement options;
generate, based on at least the data structure, the variety of arrangement options;
present, on a screen of the mobile device, the variety of arrangement options;
transmit, to the computing device associated with the financial institution, a selected arrangement of the variety of arrangements.
receive, from the computing device associated with the financial institution, the selected arrangement, wherein the selected arrangement is for use by the requestor with the entity at the unique geographic location.

18. The system of claim 17, wherein the data structure comprises a base table and an adder table.

19. The system of claim 18, wherein the adder table discloses increased rates for a requestor with a low credit score.

20. The system of claim 18, wherein the base table reflects preferred rates negotiated by a vendor at the unique geographic location and the financial institution.
